(19) United States
(12) Patent Application Publication
(10) Pub. No.: US 2013/0025907 A1
(43) Pub. Date: Jan. 31, 2013

(54) CARBON-BASED SUBSTRATE CONDUCTOR

(71) Applicants: Min Zheng, Harrisburg, PA (US); Jessica Henderson Brown Hemond, Mifflintown, PA (US); James Russell Renzas, Millbrae, CA (US); Stefanie Edith Harvey, Sunnyvale, CA (US)

(72) Inventors: Min Zheng, Harrisburg, PA (US); Jessica Henderson Brown Hemond, Mifflintown, PA (US); James Russell Renzas, Millbrae, CA (US); Stefanie Edith Harvey, Sunnyvale, CA (US)

(73) Assignee: TYCO ELECTRONICS CORPORATION, BERWYN, PA (US)

(21) Appl. No.: 13/191,243

(22) Filed: Jul. 26, 2011

(51) Int. Cl. H01B 9/02; H01B 11/02; H01B 3/30; C25D 5/54; C25D 7/06

(52) U.S. Cl. 174/105 R; 205/159; 174/110 R; 174/113 R

(57) ABSTRACT

A cable is provided having a jacket surrounding a core. A carbon-based substrate (CBS) conductor is provided in the core. The CBS conductor includes a CBS network metalized with a metalized layer. A method for manufacturing a carbon-based substrate (CBS) conductor includes providing a CBS network of CBS fibers forming a framework and metalizing at least a portion of the CBS network with a metalized layer. Optionally, the metalized layer may be at least one of a silver metalized layer, a copper metalized layer, a gold metalized layer, a nickel metalized layer, and a tin metalized layer. The CBS network may be one of a yarn, a sheet, and a tape. The CBS conductor may be a signal carrying conductor of the cable or the CBS conductor may surround the core and provide EMI shielding for the core. The cable may further include a contact terminated to the CBS conductor at the first end of the cable. The metalized layer may be provided at the interface between the CBS conductor and the contact to enhance the electrical interface between the CBS conductor and the contact.

### BACKGROUND OF THE INVENTION

The subject matter herein relates generally to carbon-based substrate (CBS) conductors, cables and other electrical components using CBS conductors and methods of manufacturing CBS conductors, cable or other electrical components using CBS conductors.

CBSs may include carbon nanotubes (CNTs), graphene or other carbon-based networks as the substrate. CBSs have use in a wide range of applications. Due to the electrical conductivity exhibited by CBSs, CBSs have application in electrical systems, such as use as electrical conductors of cables, wires or other conductors, as electromagnetic interference (EMI) shielding for cables or other types of electronic components, and other applications. Due to the relative light weight of CBSs, as compared to traditional metal components, CBSs have application in aeronautical application where weight is a significant design factor.

CBSs for use as electrical conductors are not without disadvantages. For instance, for some applications, such as for EMI shielding, the electrical conductivity of the CBS network is inadequate. Additionally, termination of the CBS to another electrical component, such as a contact, a circuit board or another electrical component has proven difficult. For example, soldering of the CBS to a contact is difficult and the CBS tends to exhibit high contact resistance at the interface. Crimping of the CBS to a contact or connector leads to poor termination and thus poor electrical results.

A need remains for a CBS network that exhibits good electrical characteristics. A need remains for a CBS network that can be terminated to make contact to a larger circuit.

### BRIEF DESCRIPTION OF THE INVENTION

In one embodiment, a cable is provided having a jacket surrounding a core. A carbon-based substrate (CBS) conductor is provided in the core. The CBS conductor includes a CBS network that is metalized with a metalized layer. For example, the CBS network may be plated with metal plating. The CBS network may be a CNT network, a graphene network or another carbon-based network.

Optionally, the metalized layer may be at least one of silver metalized layer, copper metalized layer, gold metalized layer, nickel metalized layer, and/or tin metalized layer. The metalized layer may be annealed after the metallization process.

Optionally, the CBS network may include a plurality of CNT fibers forming a framework. The CBS network may be one of a yarn, a sheet, or a tape. The CBS network may be electrically conductive. The CBS based network may be modified to create a passive dielectric or insulating component. The CBS based network may be modified to make other compounded/composite surfaces. Optionally, the metalized layer may be applied to a portion of the CBS network forming an end of the CBS conductor. Alternatively, substantially the entire CBS network may be metalized with the metalized layer. Optionally, the CBS conductor may be a signal carrying conductor of the cable. A plurality of the CBS conductors may be twisted along a length of the cable to form a central conductor of the cable. The CBS conductor may surround the core and provides EMI shielding for the core.

Optionally, the cable may further include an insulator and a second CBS conductor in the core. The insulator may surround the CBS conductor, the second CBS conductor may surround the insulator, and the jacket may surround the second CBS conductor. The second CBS conductor may provide EMI shielding for the other CBS conductor which is configured to convey electrical signals between a first end and a second end of the cable.

Optionally, the cable may further include a contact terminated to the CBS conductor at the first end of the cable. The metalized layer may be provided at the interface between the CBS conductor and the contact to enhance the electrical interface between the CBS conductor and the contact.

In another embodiment, a method for manufacturing a carbon-based substrate (CBS) conductor is provided. The method includes providing a CBS network of CBS fibers or sheets forming a framework. The method includes metalizing at least a portion of the CBS network with a metalized layer. The metalizing may include plating. The metalizing may include immersing at least a portion of the CBS network in a metallic bath. The CBS network may be formed by extracting CBS fibers from a CBS array to form the framework having a shape of one of a yarn, a tape or a sheet. The metalized CBS network may be subjected to post-processing. The metalized CBS network may be used to form a cable or as part of another electrical system.

### BRIEF DESCRIPTION OF THE DRAWINGS

FIG. 1 is a cross-sectional view of a cable formed in accordance with an exemplary embodiment.

FIG. 2 is a cross-sectional view of a cable formed in accordance with an exemplary embodiment.

FIG. 3 illustrates a cable extending between a first and a second end.

FIG. 4 is an enlarged view of a portion of a carbon-based substrate (CBS) conductor formed in accordance with an exemplary embodiment.

FIG. 5 is a cross-sectional view of a CBS conductor formed in accordance with an exemplary embodiment.

FIG. 6 is a cross-sectional of a CBS connector formed in accordance with an exemplary embodiment.

FIG. 7 is a cross-sectional view a CBS connector formed in accordance with an exemplary embodiment.

FIG. 8 illustrates a processor system for manufacturing a CBS conductor in accordance with an exemplary embodiment.

FIG. 9 is a flow chart showing a method of manufacturing a cable in accordance with an exemplary embodiment.

FIG. 10 illustrates an electrical component that incorporates a CBS conductor.

### DETAILED DESCRIPTION OF THE INVENTION

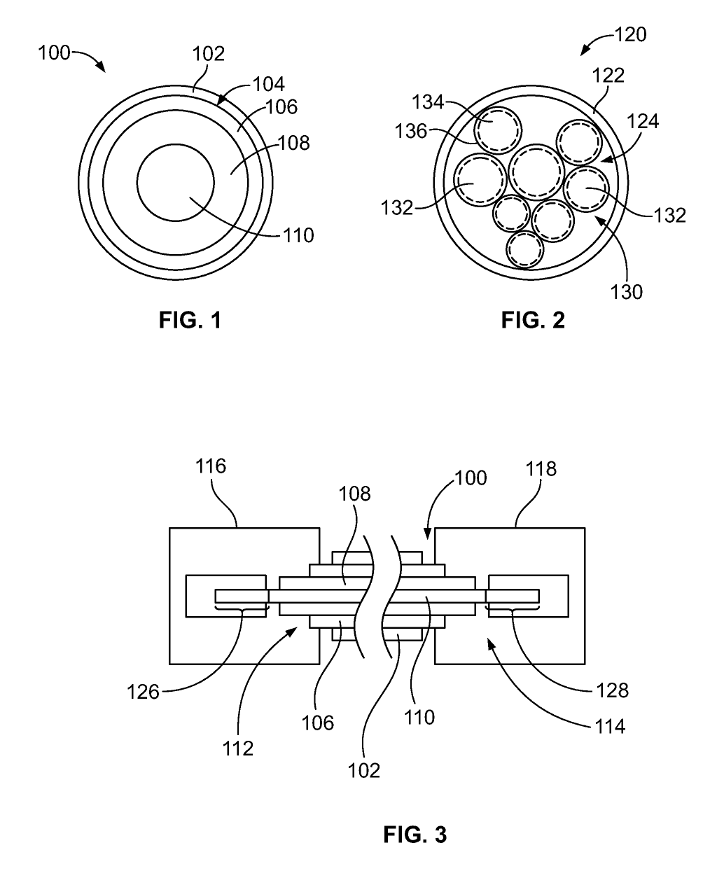

FIG. 1 is a cross-sectional view of a cable 100 formed in accordance with an exemplary embodiment. The cable 100 includes a jacket 102 defining a core 104. An EMI shield 106 is in the core 104 and is surrounded by the jacket 102. An insulator 108 is in the core 104 and is surrounded by the EMI shield 106. A center conductor 110 is in the core 104 and is surrounded by the insulator 108. The insulator 108 electrically isolates the center conductor 110 from the EMI shield 106. The insulator 108 is manufactured from a dielectric material. Optionally, the insulator 108 may be a shrink tube that is heat shrinkable. The jacket 102 is manufactured from a dielectric material. Optionally, the jacket 102 may be a shrink tube that is heat shrinkable. Optionally, the cable 100 may include a drain or ground wire.

The EMI shield 106 and the center conductor 110 are electrically conductive. The cable 100 defines a coaxial cable having the center conductor 110 and an outer conductor defined by the EMI shield 106 extending along a common axis along the length of the cable 100. The cable 100 may be another type of cable, such as a twin-axial cable, a quad-axial cable, an unshielded cable, and the like. The center conductor 110 is configured to convey electrical signals between a first end 112 (shown in FIG. 3) and a second end 114 (shown in FIG. 3) of the cable 100. In an exemplary embodiment, the center conductor 110 is configured to convey data signals. Alternatively, the center conductor 110 may convey power between the first and second ends 112, 114. In other alternative embodiments, the cable 100 may include more than one center conductors that define different electrical paths to convey different electrical signals.

In an exemplary embodiment, the center conductor 110 and the EMI shield 106 are manufactured from a carbon-based substrate (CBS), such as carbon nanotubes (CNTs), graphene, a graphite oxide structure, and the like. Alternatively, the center conductor 110 and the EMI shield 106 are manufactured from another nano-substrate, such as a ceramic nanowire, such as a boron nitride substrate. The CBS based network may be modified to create other types of electronic components such as a passive dielectric or insulating component. The CBS based network may be modified to make other compounded/composite surfaces.

The center conductor 110 defines a CBS conductor, and may be referred to hereinafter as a CBS conductor 110. Optionally, the center conductor 110 may include one or more strands of CBS conductors that are twisted together during a cable forming process. The EMI shield 106 defines a CBS conductor, and may be referred to hereinafter as a CBS conductor 106. In an alternative embodiment, only the center conductor 110 is manufactured from a CBS. In another alternative embodiment, only the EMI shield 106 is manufactured from a CBS.

In an exemplary embodiment, each CBS conductor 106, 110 is manufactured from a CBS network that is at least partially metalized with a metalized layer. The metalized layer may be a single layer or multiple layers. The metalized layer may be a coating surrounding an outer surface of the CBS network or may at least partially permeate through, or be infused into, the CBS network. The CBS network may be a CNT network, a graphene network or another carbon-based network. Optionally, select portions of the CBS conductors 106, 110 may be metalized with the metalized layer. Alternatively, substantially the entire CBS conductors 106, 110 may be metalized with the metalized layer. In an exemplary embodiment, the metalized layer is a silver metalized layer, such as a silver plating. In other embodiments, the metalized layer may be other types of metalized layers, such as a copper metalized layer, a gold metalized layer, a nickel metalized layer, a tin metalized layer and the like. The type of metal used for metalizing is selected to enhance certain characteristics of the CBS network, such as the electrical characteristics, the mechanical characteristics, the solderability characteristics and the like. Optionally, different parts of the CBS conductors 106, 110 may be metalized with different types of metalized layers. Optionally, different portions of the CBS conductors 106, 110 may be metalized with more than one metalized layers or materials, making a multi-layered metalized substrate. For example, the entire CBS network may be metalized with one metalized layer, such as a silver plating, to make the CBS conductor more conductive and ends of the CBS conductors may be metalized with another metalized layer, such as a tin plating, to make the CBS conductor more solderable.

In an exemplary embodiment, the metalized layer is electroplated. The metalized layer may be applied by other processes in alternative embodiments. Optionally, portions or all of the CBS network may be subjected to surface functionalization to introduce chemical functional groups to at least a portion of the surface of the CBS network. For example, functionalization of the ends of CBS fibers, bundles, yarns, tapes or sheets may be performed. The functionalization process may include corona discharge and/or plasma treatment, such as plasma treatments at energy levels sufficient to break all bond types (e.g., VanDerWaal-London through covalent). The functionalization process may include wet chemistry. The functionalization process may include in situ functionalization during chemical vapor deposition (CVD) treatment by use of chemical gas mixtures. The metallization may include, either with or without prior functionalization, physical vapor deposition, metallo-organic CVD in-situ, dip coating in conductive ink/paste, or other processes to metalize the CBS network.

The metalized layer may be further processed to enhance the characteristics of the conductor. For example, the metalized layer may be annealed after being applied. Other processes may be utilized in alternative embodiments.

FIG. 2 is a cross-sectional view of another cable 120 formed in accordance with an exemplary embodiment. The cable 120 includes a jacket 122 defining a core 124. A center conductor 130 is provided in the core 124. The center conductor 130 includes a plurality of strands 132 of CBSs that are twisted together during a cable forming process to form the center conductor 130. Any number of strands 132 may be provided.

In an exemplary embodiment, each strand 132 is a separate CBS conductor manufactured from a CBS network 134 that is metalized with a metalized layer 136. The CBS network 134 may be selectively metalized to different portions of the CBS conductor. In the illustrated embodiment, the metalized layer 136 is provided around the outer perimeter of the CBS network 134. In alternative embodiments, the metalized layer 136 may extend or permeate entirely through the CBS network 134 such that the CBS network 134 is metalized entirely therethrough.

FIG. 3 illustrates the cable 100 extending between the first and second ends 112, 114. The cable 100 may have any length defined between the first and second ends 112, 114. The first end 112 is terminated to a first electrical component 116. The second end 114 is terminated to a second electrical component 118.

The first and second electrical components 116, 118 are represented schematically in FIG. 3. The first and second electrical components 116, 118 may be any type of electrical component. Optionally, the first electrical component 116 may be different than the second electrical component 118. The electrical components 116, 118 may be electrical contacts, electrical connectors, circuit boards, or other types of electrical components. The center conductor 110 and/or EMI shield 106 may be electrically connected to the electrical component 116, 118. The center conductor 110 and/or EMI shield 106 are configured to electrically connect the first and second electrical components 116, 118. Optionally, the cable 100 may be soldered to the electrical components 116 and/or 118. For example, the CBS conductor 110 and/or 106 may be soldered to an electrical contact or other type of electrical component. The cable 100 may be terminated to the electrical components 116, 118 by alternative means or processes in alternative embodiments, such as by crimping. In an exemplary embodiment, the CBS-based center conductor 110 is soldered to electrical contacts, such as pins, and the CBS-based EMI shield 106 is crimped to shells of the electrical components, such as shells of an SMA connector.

In an exemplary embodiment, the CBS network of the CBS conductor is conductive and is configured to convey electrical signals between the first and second electrical components 116, 118. The metalized layer may enhance the electrical properties of the center conductor 110 and/or EMI shield 106. For example, the conductivity of the CBS-based center conductor 110 and/or EMI shield 106 may be increased by selecting a metal material having a high conductivity, such as silver, copper, gold, nickel, tin and the like. The CBS-based center conductor 110 and/or EMI shield 106 may be easier to solder with the addition of the metalized layer either at the ends 112, 114 and/or along the entire length of the cable 100 by lowering the contact resistance of the center conductor 110 and/or EMI shield 106.

In the illustrated embodiment, the EMI shield 106 is metalized along the entire length of the CBS network to increase the conductivity of the CBS network to provide shielding along the entire length. In the illustrated embodiment, the center conductor 110 is metalized only at the ends 112, 114, such as in the exposed areas 126, 128 of the center conductor 110, which are the areas that are configured to be soldered to the electrical components 116, 118. The metalizing at the areas 126, 128 reduces the contact resistance at the interface between the CBS network and the electrical components 116, 118. The metalizing at the areas 126, 128 may increase the solderability at the interface between the CBS network and the electrical components 116, 118. By selectively metalizing only in the areas 126, 128, the overall cost of the cable 100 may be reduced. It is realized that the entire center conductor 110 or other portions of the center conductor 110 other than the areas 126, 128 may also be metalized. In an exemplary embodiment, the entire center conductor 110 is metalized, such as with silver, to increase the electrical conductivity of the center conductor 110 and the ends 112, 114 are metalized, such as with tin, to increase the solderability of the center conductor 110.

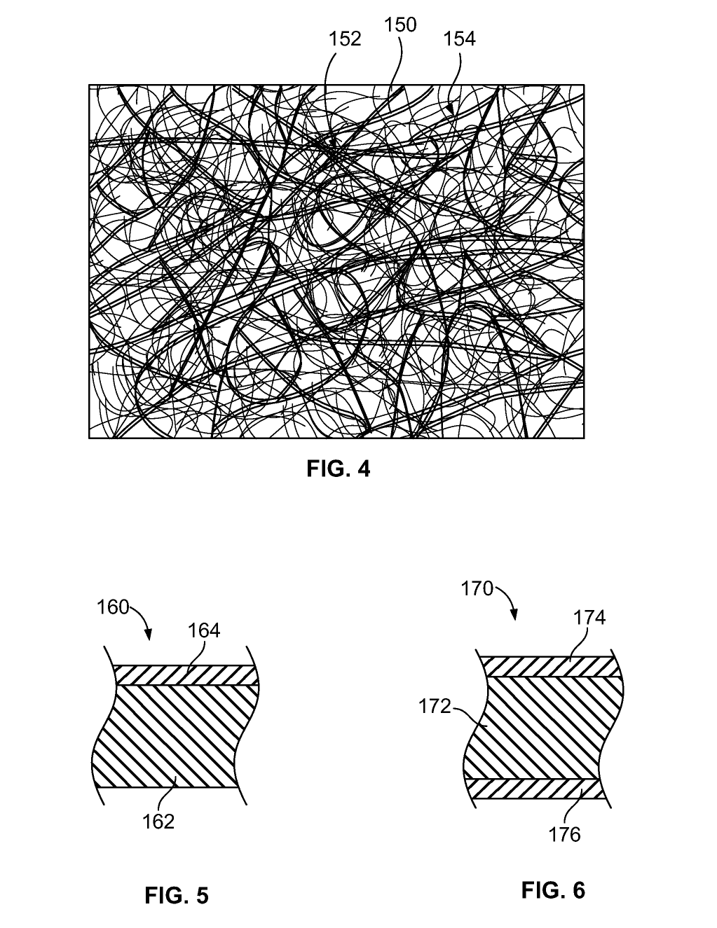

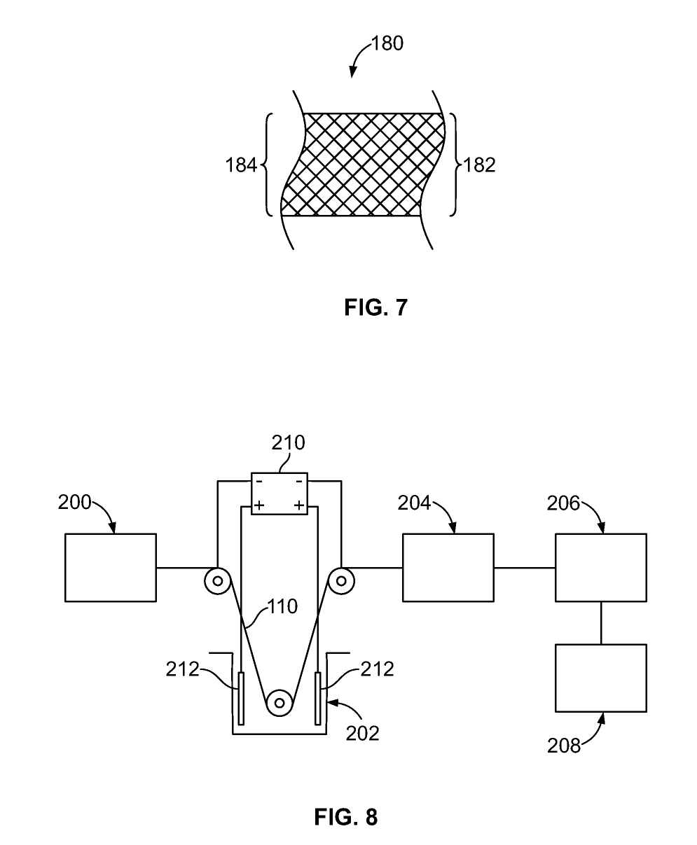

FIG. 4 is an enlarged view of a portion of the CBS conductor 110 formed in accordance with an exemplary embodiment. The CBS conductor 110 includes a plurality of CBS fibers 150, such as CNT fibers, that are arranged to form a framework 152 that defines the CBS network. The CBS network is metalized with the metalized layer 154 to enhance the characteristics of the CBS structure. Optionally, the CBS network may be placed into a metallic bath for plating the CBS network. All or portions of the CBS network may be plated to form the metalized layer 154. The metal plating may be applied by an electroplating process. The CBS network may be metalized using other processes in alternative embodiments, such as physical vapor deposition, metallo-organic CVD in-situ, dip coating in conductive ink/paste, or other processes to metalize the CBS network. The metalized layer 154 may be a continuous, outer metal layer (e.g., see FIGS. 5 and 6) to wrap at least a portion of the CBS network. The metalized layer 154 may penetrate the CBS network to form a CBS-metal particle network (e.g., see FIG. 7) by controlling the amount of time, the concentration of the metal and/or current that the CBS network is subjected to the metallization process. The electrical characteristic enhancement of the metallization may be tuned by controlling the concentration and/or time of exposure in the metallic bath.

In an exemplary embodiment, the framework 152 may be pulled from a CBS array or CBS source, such as by using a spinning technique. The framework 152 may be formed into a yarn or wire. The framework 152 may be a braided yarn or a mesh. Alternatively, the framework 152 may be formed into a tape. Alternatively, the framework 152 may be formed into a sheet. The wire, tape or sheet may have any length depending on the particular application. A wire is defined as having a width that is less than approximately two times a thickness of the framework 152. A tape is defined as having a width that is greater than approximately two times the thickness of the framework 152 and having a width that is less than approximately ten times the thickness of the framework 152. A sheet is defined as a framework having a width that is greater than approximately ten times the thickness of the framework 152. The framework 152 may have different shapes depending on the particular application.

The wires or yarns may be used, for example, to define the strands of the center conductor 110 (shown in FIG. 1). The tapes may be used, for example, to form the EMI shield 106 (shown in FIG. 1), wherein the framework 152 may be wrapped around the internal components of the cable 100 such that the opposite edges of the framework 152 touch one another or overlap one another. In other embodiments, the tape may be wrapped in a helical manner around the insulator and center conductor 108, 110 to form an EMI shield. In other alternative embodiments, the tapes may be used to form wires or conductors of a cable, such as by drawing the tape during a cable forming process. The drawing of the tape may occur either pre or post metalizing. The sheet may be used, for example, as an EMI shield that covers an electrical component, such as a housing of a connector to provide EMI shielding for the connector. The framework 152 may have any other shape suitable for the particular application capable of being formed from a CBS structure.

FIG. 5 is a cross-sectional view of a CBS conductor 160 formed in accordance with an exemplary embodiment. The CBS conductor 160 includes a CBS network 162 and a metalized layer 164 applied to one side of the CBS network 162. The CBS network 162 comprises a plurality of CBS fibers that form a framework. The CBS connector 160 may be formed by bathing one side of the CBS network 162 in a metallic bath to form the metalized layer 164 on one side of the CBS network 162. Other processes may be used to form the metalized layer 164. A thickness of the metalized layer 164 may be controlled by controlling an amount of time the CBS network 162 is in the metallic bath. The metalized layer 164 may be a continuous metal layer cover the outer surface of the CBS network 162. The metalized layer 164 may be bonded to the CBS network 162.

FIG. 6 is a cross-sectional of a CBS connector 170 formed in accordance with an exemplary embodiment. The CBS connector 170 includes a CBS network 172 and a metalized layer 174 on one side of the CBS network 172 and another metalized layer 176 on a second side of the CBS network 172. The metalized layers 174, 176 may be part of the same metalized layer that entirely circumferentially surrounds the CBS network 172. The CBS connector 170 may be manufactured by bathing the entire CBS network 172 in a metallic bath to provide the metalized layers 174, 176 on all or both sides of the CBS network 172. A thickness of the metalized layers 174, 176 may be controlled by controlling an amount of time the CBS network 172 is being metalized. The metalized layers 174, 176 may be continuous metal layers covering the outer surface of the CBS network 172. The metalized layers 174, 176 may encapsulate the CBS network. The metalized layers 174, 176 may be bonded to the CBS network 172.

FIG. 7 is a cross-sectional view a CBS connector 180 formed in accordance with an exemplary embodiment. The CBS connector 180 includes a CBS network 182 and a metalized layer 184 entirely through the CBS network 182. The CBS conductor 180 may be formed by placing the CBS network 182 in a metallic bath for sufficient time to allow the CBS network to be wetted entirely such that the metalized layer penetrates and is infused in the CBS network 182. The metalized layer 184 penetrates the CBS network 182 to form a CBS-metal particle network. Metal particles of the metalized layer 184 may be located at any location of the CBS network 182, not just at the outer surface of the CBS network 182.

FIG. 8 illustrates a processor system for manufacturing a CBS conductor, such as the CBS conductor 110, in accordance with an exemplary embodiment. A CBS array 200 is provided as a source of carbon fibers, such as carbon nanotubes or carbon sheets. A metallic bath 202 is provided. A post-processing module 204 is provided. A cable forming module 206 is provided. A storage module 208 is provided. Other modules may be provided in alternative embodiments.

During manufacture, CBS fibers are pulled or otherwise extracted from the CBS array 200 to make a framework or CBS network. The CBS network may be taken in the form of a wire or yarn, a tape, a sheet and the like. The CBS network is then metalized. In the illustrated embodiment, the CBS network is plated, however other processes may be used in alternative embodiments to metalize the CBS network. The CBS network is directed to the metallic bath 202 where the CBS network is plated with metal plating. Optionally, the CBS network may be electroplated. A power supply 210 may be provided with one or more stainless steel bars 212, or other metallic bars, electrically connected to the power supply 210. The stainless steel bars 212 may be connected to the positive terminal(s) of the power supply 210 to define an anode(s). The CBS network may be electrically connected to the power supply 210, such as to the negative terminal(s), to define a cathode. The metal plating is applied to the CBS network when power is supplied to the metallic bath 202 via the bars 212 and/or the CBS network. Optionally, portions of the CBS network may be selectively plated. Optionally, more than one metallic baths may be provided.

The metalized CBS network is directed to the post-processing module 204. At the post-processing module 204 the CBS conductor may be subjected to heating, cooling, shrinking, twisting, doping, densification, pressing, forming or other processes to affect the interaction between the metalized layer and the CBS network and/or to define a shape of the CBS conductor.

The CBS conductor is directed to the cable forming module 206 to form a cable, such as the cable 100 (shown in FIG. 1). At the cable forming module 206, one or more of the CBS conductors are used to form the cable 100. For example, one or more CBS conductors in tape or sheet form may be wrapped around the center conductor to form an outer conductor or EMI shield. After the cable is formed, the cable may be stored at the storage module 208.

In alternative embodiments, rather than using the CBS conductors to form cables, the CBS conductors may be used to form other electrical components, such as an electrical connector, a processor, a circuit board, or another electrical component. The CBS conductor may be used as part of a signal conductor or alternatively may be part of an EMI shield or another part of an electrical component.

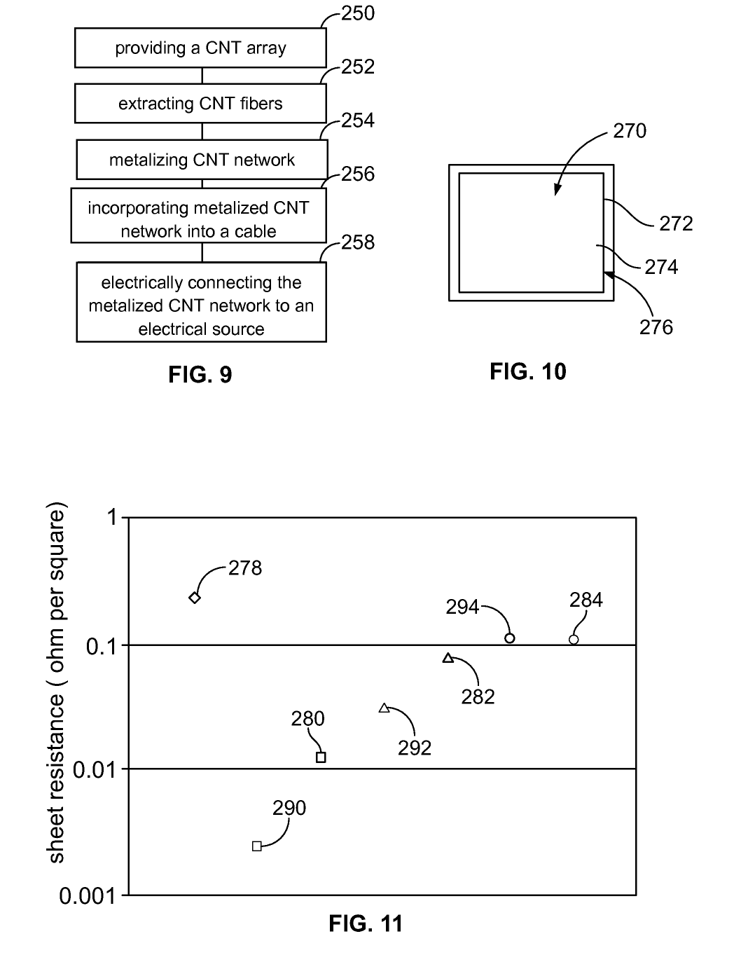

FIG. 9 is a flow chart showing a method of manufacturing a cable in accordance with an exemplary embodiment. The method includes providing 250 a CBS array as a source of fibers. The method includes extracting 252 CBS fibers from the CBS array to form a framework. The framework may be formed in any shape, such as a wire or yarn, a tape, a sheet or another shape. The method includes metalizing 254 the CBS network or framework, such as in a metallic bath or by another process. Optionally, the metalizing 254 may include electroplating. The metalizing 254 may include electrically coupling the CBS network to a power supply to function as a cathode or an anode.

The method includes incorporating 256 the metalized CBS network into a cable. For example, the CBS network may be presented to a cable forming machine that pulls the CBS network into a cable form within a jacket. The method includes electrically connecting 258 the CBS network to an electrical source to form a CBS conductor. For example, the CBS network may be soldered to a contact, a circuit board or another electrical component at one or both ends of the CBS network, and data signals may be conveyed along the CBS network between the opposite ends of the cable.

The metalized CBS network may be used in other types of electrical systems other than a cable, such as an electrical connector, a microprocessor, or another type of electrical component. Any application suitable for use with CBSs may utilize the metalized CBSs. The metalized layer on the CBS network enhances the characteristics of the CBS network, such as electrically, mechanically, for solderability and the like.

FIG. 10 illustrates an electrical component 270 that incorporates a CBS conductor 272. In the illustrated embodiment, the CBS conductor 272 is used as an EMI shield for electrical component 270. For example, the CBS conductor 272 may be a sheet or tape wrapped around an exterior of the electrical component 270. The electrical component 270 may be an electrical connector having a housing 274 with an outer surface 276. The CBS conductor 272 may be applied to the outer surface 276 to provide shielding for the electrical component 270.

FIG. 11 illustrates an exemplary chart of measured sheet resistance for different exemplary CBS conductors. The sheet resistance is measured in ohms per square unit. The chart shows reduction in sheet resistance for metalized CBS conductors 280-294 as compared to an un-metalized CBS conductor 278. The chart shows sheet resistance measurements for a silver metalized CBS conductor 280, a copper metalized CBS conductor 282 and a gold metalized CBS conductor 284. The chart shows sheet resistance measurements for an annealed silver metalized CBS conductor 290, an annealed copper metalized CBS conductor 292 and an annealed gold metalized CBS conductor 294.

In the illustrated embodiment, the measured sheet resistance of the un-plated CBS conductor 278 is approximately 0.4. The measured sheet resistance of the silver metalized CBS conductor 280 is approximately 0.01. The measured sheet resistance of the copper metalized CBS conductor 282 is approximately 0.09. The measured sheet resistance of the gold metalized CBS conductor 284 is approximately 0.1. The measured sheet resistance of the annealed silver metalized CBS conductor 290 is approximately 0.004. The measured sheet resistance of the annealed copper metalized CBS conductor 292 is approximately 0.05. The measured sheet resistance of the annealed gold metalized CBS conductor 294 is approximately 0.1. All of the metalized CBS conductors 280-294 have lower sheet resistance than the un-plated CBS conductor 278, and thus have improved electrical characteristics as compared to the un-plated CBS conductor 278.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A cable comprising:
a jacket surrounding a core; and
a carbon-based substrate (CBS) conductor in the core, the CBS conductor comprising a CBS network metalized with metalized layer.

2. The cable of claim 1, wherein the metalized layer comprises a silver metalized layer.

3. The cable of claim 1, wherein the metalized layer comprises at least one of a silver metalized layer, a copper metalized layer, a gold metalized layer, a nickel metalized layer, and a tin metalized layer.

4. The cable of claim 1, wherein the metalized layer is annealed after being metalized.

5. The cable of claim 1, wherein the CBS network includes a plurality of fibers forming a framework.

6. The cable of claim 1, wherein the CBS network comprises one of a yarn, a sheet, and a tape.

7. The cable of claim 1, wherein the CBS network is electrically conductive.

8. The cable of claim 1, wherein the metalized layer is applied to a portion of the CBS network forming an end of the CBS conductor.

9. The cable of claim 1, wherein substantially the entire CBS network is metalized with the metalized layer.

10. The cable of claim 1, wherein the CBS conductor comprises a signal carrying conductor of the cable.

11. The cable of claim 1, further comprising a plurality of the CBS conductors twisted along a length of the cable to form a central conductor of the cable.

12. The cable of claim 1, wherein the CBS conductor surrounds the core and provides EMI shielding for the core.

13. The cable of claim 1, wherein the cable comprises a coaxial cable having an insulator and a second CBS conductor in the core, the insulator surrounding the CBS conductor, the second CBS conductor surrounding the insulator, the jacket surrounding the second CBS conductor, the second CBS conductor providing EMI shielding for the other CBS conductor, which is configured to convey electrical signals between a first end and a second end of the cable.

14. The cable of claim 13, further comprising a contact soldered to the CBS conductor at the first end of the cable, the metalized layer being provided at the interface between the CBS conductor and the contact, the metalized layer being soldered to the contact.

15. A carbon-based substrate (CBS) conductor comprising:
a CBS network; and
a metalized layer on the CBS network.

16. The CBS conductor of claim 15, wherein the metalized layer penetrates entirely through the CBS network.

17. A method for manufacturing a carbon-based substrate (CBS) conductor comprising:
providing a CBS network of CBS fibers forming a framework; and
metalizing at least a portion of the CBS network with a metalized layer.

18. The method of claim 17, wherein the metalizing comprises immersing at least a portion of the CBS network in a metallic bath, and wherein the metalizing comprises electrically connecting the CBS network to a power source such that the CBS network defines one of a cathode or an anode in the metallic bath.

19. The method of claim 17, wherein the providing a CBS network comprises extracting CBS fibers from a CBS array to form the framework having a shape of one of a yarn, a tape or a sheet.

20. The method of claim 17, further comprising post-processing the metalized CBS network.
